(19) United States
(12) Patent Application Publication
(10) Pub. No.: US 2005/0079862 A1
(43) Pub. Date: Apr. 14, 2005

(54) Mobile terminal device, program and system

(76) Inventors: Taku Takaki, Fujisawa (JP); Makoto Katagishi, Chigasaki (JP)

Correspondence Address: MCDERMOTT, WILL & EMERY, 600 13th Street, N.W., Washington, DC, 20005-3096, US

(21) Appl. No.: 10/803,084

(22) Filed: Mar. 18, 2004

(30) Foreign Application Priority Data
Oct. 10, 2003 (JP) 2003-351515

(51) Int. Cl. H04B 7/00

(52) U.S. Cl. 455/418; 455/41.2

(57) ABSTRACT

The present invention is a signal processing system for a wireless communication signal to provide a mobile terminal device capable of promoting the prohibition and limitation of communication functions. The signal processing system uses a mobile terminal device, a server, and a network base station transmitting the wireless communication signal. In exchange for predetermined contents transmitted from the server being received by the mobile terminal device, the wireless communication signal transmitted from the network base station to the mobile terminal device is not received in the mobile terminal device.

### BACKGROUND OF THE INVENTION

1. Filed of the Invention

The present invention relates to a mobile terminal device, a program for the mobile terminal device, and a signal processing system using the mobile terminal device.

2. Description of the Related Art

Conventionally, a method of prohibiting or limiting communication by mobile terminal devices in specific facilities or places (hospitals, movies, theaters, etc.) has been proposed (Japanese Patent Laid-Open No. 2002-84571). According to this method, while only communication functions of the mobile terminal devices are turned off to disable communication, other functions are made available. Specifically, even in facilities where communication by mobile terminal devices is prohibited or limited, functions other than communication functions such as display of incoming mail, schedule confirmation, and the like are made available to promote the prohibition and limitation of communication by the mobile terminal devices.

### BRIEF SUMMARY OF THE INVENTION

However, in the aforementioned patent publication, in exchange for turning off communication functions, only display of incoming mail, schedule confirmation, and the like can be performed using data having already been captured in the mobile terminal devices. This is insufficient to promote the prohibition or limitation of communication functions.

Specifically, in the aforementioned patent publication, even when communication functions are prohibited or limited, users cannot be provided with new services and contents and cannot receive contents not captured in the mobile terminal devices from the outside. Therefore, the aforementioned patent has been insufficient as a method for prohibiting or limiting communication functions.

To achieve the aforementioned object, the present invention provides a program received in a mobile terminal device. The mobile terminal device has a button, and when the decision button has been pressed, the program is received by the mobile terminal device in exchange for the mobile terminal device being unable to receive a wireless communication signal. In a signal processing system for a wireless communication signal that uses a mobile terminal device, a server, and a network base station transmitting the wireless communication signal, in exchange for predetermined contents transmitted from the server being received by the mobile terminal device, the wireless communication signal transmitted from the network base station to the mobile terminal device is not received in the mobile terminal device. As a result, the present invention contributes to improvement in manners of the use of cellular phones.

### BRIEF DESCRIPTION OF SEVERAL VIEWS OF THE DRAWING

These and other objects, features and advantages of the present invention will become more readily apparent from the following detailed description when taken in conjunction with the accompanying drawing wherein:

FIG. 1 is a diagram showing an example 1 of the configuration of a mobile terminal device;

FIG. 2 is a diagram showing an example of a processing procedure for entrance to a facility in the configuration example 1;

FIG. 3 is a diagram showing an example of a processing procedure for exit from the facility in the configuration example 1;

FIG. 4 is a diagram showing an example 2 of the configuration of a mobile terminal device;

FIG. 5 is a diagram showing an example of a processing procedure in the configuration example 2;

FIG. 6 is a diagram showing an example of screen display of a mobile terminal device;

FIG. 7 is a diagram showing an example of screen display of a mobile terminal device;

FIG. 8 is a diagram showing an example of screen display of a mobile terminal device;

FIG. 9 is a diagram showing an example of screen display of a mobile terminal device; and

FIG. 10 is a system diagram relating to the present invention.

### DETAILED DESCRIPTION OF THE INVENTION

Hereinafter, this embodiment will be described using the drawings.

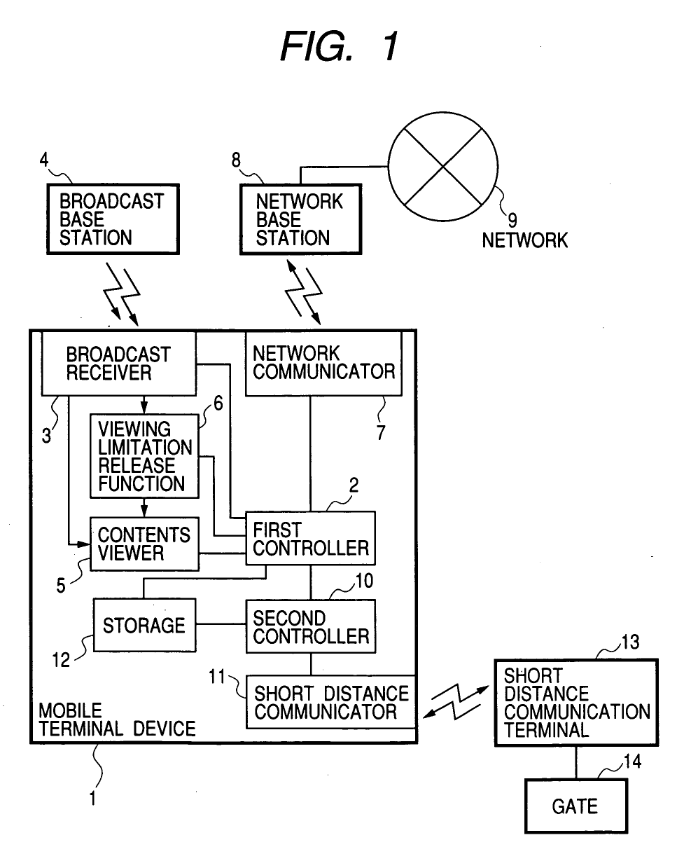

Referring to FIG. 1, a description is made of an example of the configuration of a mobile terminal device proposed by the present invention. FIG. 1 is a functional block diagram of the mobile terminal device.

A first controller 2 controls various parts of the mobile terminal device 1. A broadcast receiver 3, controlled by the first controller 2, receives contents broadcast from a broadcast base station 4 and outputs them to a contents viewer 5.

The contents viewer 5 comprises interfaces such as a liquid crystal display and a speaker that enable a user to view contents information outputted from the broadcast receiver 3. It is controlled by the first controller 2.

Contents broadcast include limited-viewing contents. The limited-viewing contents are those limited so as to be normally viewed in the contents viewer by releasing viewing limitations by a predetermined method. Viewing limitations here refer to user limitations or reproduction limitations such as encryption and scramble. The reproduction limitations may include such a limitation as not to reproduce contents at all. A viewing limitation release function 6, controlled by the first controller 2, releases viewing limitations of limited-viewing contents.

A network communicator 7, controlled by the first controller 2, can be connected with a network 9 over communication with a network base station 8. The network communicator 7 can be activated or inactivated by the first controller 2, independently of other components. For example, the first controller can inactivate the network communicator 7 while activating the broadcast receiver 3, the contents viewer 5, and the viewing limitation release function 6. The inactivation state refers to the state in which power emission to the network base station is halted by totally or partially halting the power supply to the communicator 7.

In this case, the user can view contents distributed from the broadcast base station 4 in the state in which power emission from the mobile terminal device 1 to the network base station 8 is halted.

The second controller 10 controls a short distance communicator 11 and a storage 12.

The short distance communicator 11, controlled by the second controller 10, makes communication with a short distance communication terminal 13 and can receive power from the short distance communication terminal 13.

The storage 12, controlled by the first controller 2 and the second controller 10, can store a viewing limitation release key. The viewing limitation release key, which is a key for performing decoding, descramble, or the like, is used to release user limitations or reproduction limitations.

The second controller 10, the short distance communicator 11, and the storage 12 operate on power supplied without contact from the short distance communication terminal 13. They form a configuration of non-contact IC, for example.

A gate 14 is one through which a facility user passes at the time of exit from the facility, and can be opened or closed by the short distance communication terminal 13.

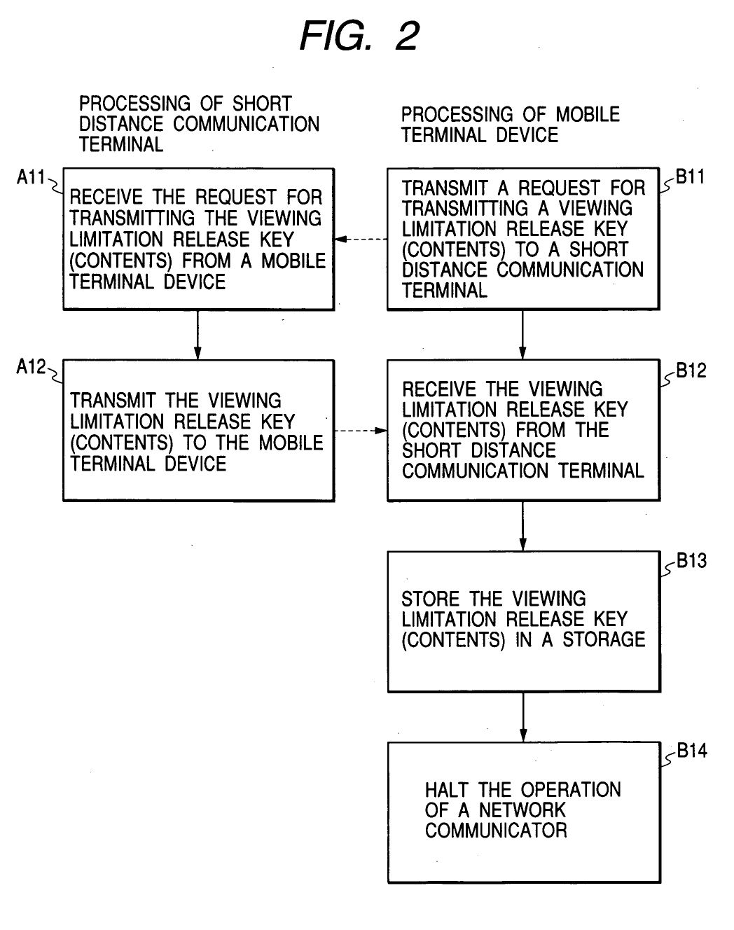

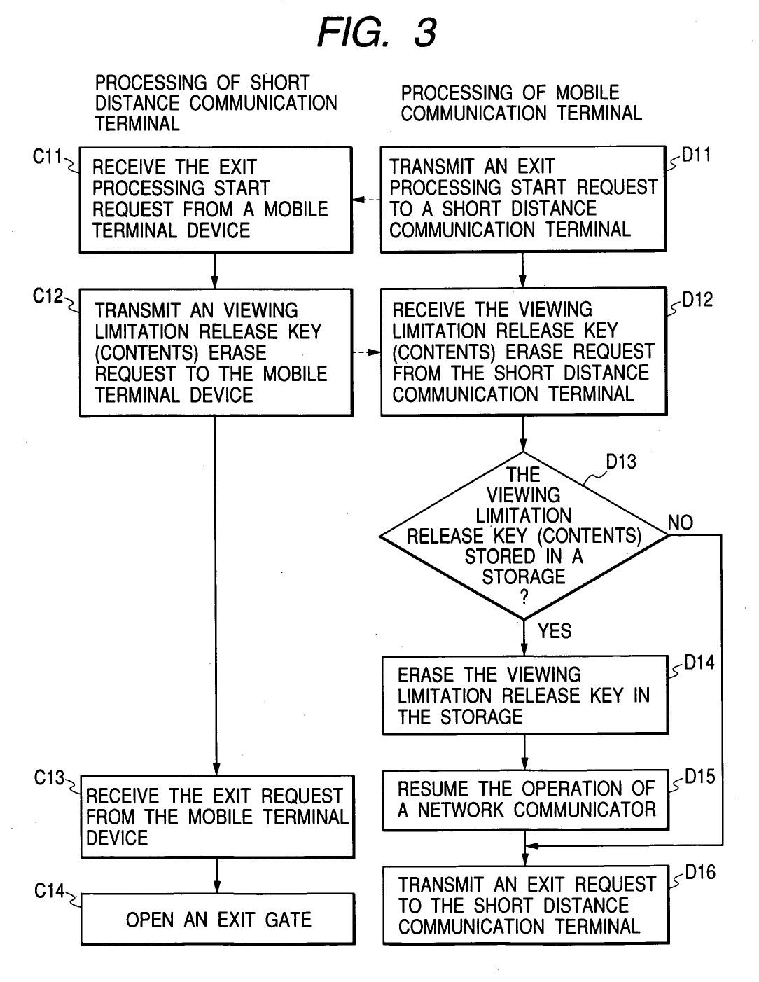

Next, referring to FIGS. 2 and 3, a description is made of a procedure for enabling to view specific limited-viewing contents in exchange for the halt of network communication functions within a facility. FIG. 2 shows a procedure of control by the mobile terminal device 1 and the short distance communication terminal 13 to enable to view limited-viewing contents. FIG. 3 shows a procedure at the time of exit from the facility.

This example assumes that the facility has one or more of the short distance communication terminal 13 and is provided with the gate 14 for exit, and facility users always pass through the gate at the time of exit. Also, this example assumes that viewing limited-viewing contents is controlled by encryption, and by storing the viewing limitation release key for canceling encryption in the storage 12, encryption is canceled by the viewing limitation release function 6, so that the contents can be normally viewed.

The aforementioned method of limiting contents viewing and method of releasing viewing limitations do not limit the present invention; any methods are permitted which enable contents viewing limitations to be released by storing the viewing limitation release key equivalent to a contents viewing right in the storage. For example, setting is made so that a channel for viewing contents cannot be selected, and control may be performed by the first controller 2 so that the channel can be selected when the viewing limitation release key has been stored in the storage 12.

After a user enters the facility, the mobile terminal device 1 is brought near the short distance communication terminal 13 to perform predetermined operations. This makes the second controller 10 transmit a viewing limitation release key transmission request to the short distance communication terminal 13 installed in the facility through the short distance communicator 11 (procedure B11).

Upon receiving the viewing limitation release key transmission request (procedure A11), the short distance communication terminal 13 transmits a viewing limitation release key to the mobile terminal device 1 (procedure A12).

Upon receiving a viewing limitation release key from the short distance communication terminal 13 (procedure B12), the second controller 10 stores the received key in the storage 12 (procedure B13), and the first controller 2 halts the operation of the network communicator 7 (procedure B14).

As long as the viewing limitation release key is stored in the storage 12, the first controller 2 uses the viewing limitation release function 6 to output limited-viewing contents to the contents viewer 5 so that they can be viewed. As long as the viewing limitation release key is stored in the storage 12, the first controller 2 halts the operation of the network communicator 7. The viewing limitation release key stored in the storage 12 can be erased only by an exit procedure described later, and cannot be erased by a user's request. When exiting from the facility, the user brings the mobile terminal device 1 near the short distance communication terminal 13 and performs predetermined operations. With this, the second controller 10 transmits an exit processing start request to the short distance communication terminal 13 installed in the facility through the short distance communicator 11 (procedure D11). Upon receiving the exit processing start request (procedure C11), the short distance communication terminal 12 transmits a viewing limitation release key erase request to the mobile terminal device 1 (procedure C12).

Upon receiving the viewing limitation release key erase request from the short distance communication terminal 13 (procedure D12), when the viewing limitation release key is stored in the storage 12 (procedure D13-yes) the second controller 10 erases the viewing limitation release key (procedure D14), and the first controller 2 activates the network communicator 7 (procedure D15) In procedure D13, when the viewing limitation release key is not stored in the storage 12, procedures 13 and 14 are not executed (procedure D13-no).

Next, the second controller 10 transmits a gate opening request to the short distance communication terminal 13 (procedure D16). Upon receiving the gate opening request (procedure C13), the short distance communication terminal 13 opens the exit gate 14 (procedure C14).

By a series of these operations, in the case where the user selects access to limited-viewing contents to which the viewing limitation release key is offered from the facility, the operation of the network communicator 7 is halted in the facility, contributing to the promotion of the halt of functions for communication with the network within the facility, based on user's will.

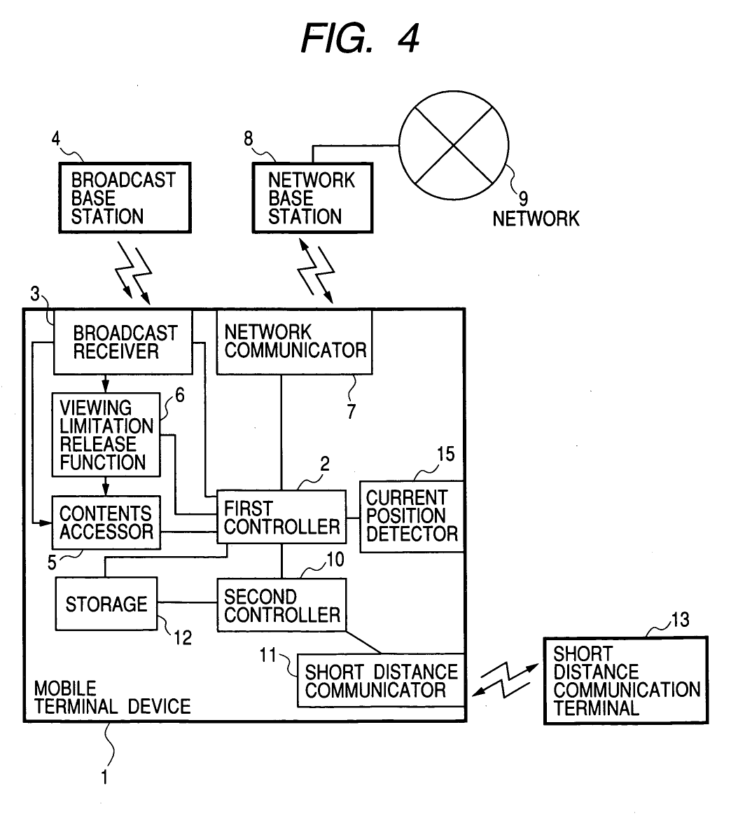

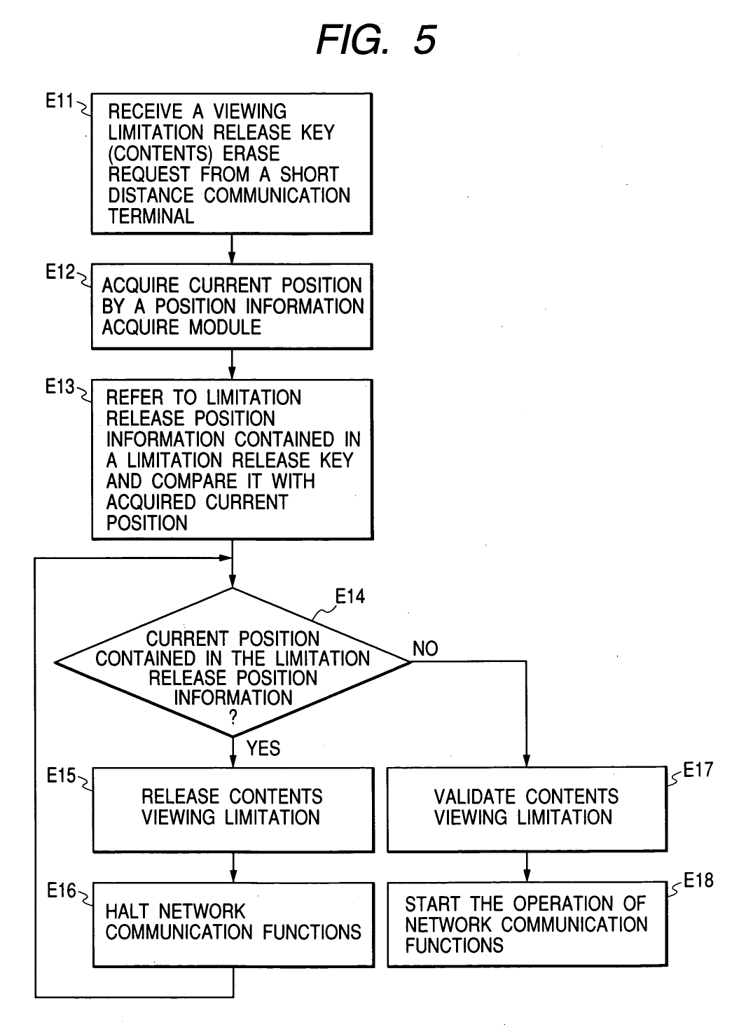

Heretofore, a description has been made of an example of erasing the viewing limitation release key without fail at the time of exit by managing exits at the gate 14. However, an exit from the facility may be judged based on current position information of the mobile terminal device 1. In this case, the viewing limitation release key of the terminal becomes valid or invalid according to the current position information of the mobile terminal device 1. Hereinafter, the aforementioned example will be described with reference to FIGS. 4 and 5.

It is assumed here that the mobile terminal device includes a GPS-based current position detector 15. Also, it is assumed that a viewing limitation release key distributed from the facility contains limitation release position information. The limitation release position information is used by the first controller 2 to judge whether the viewing limitation release key is valid or invalid, and the first controller 2 performs control so that the viewing limitation release key becomes valid only in that position.

When the viewing limitation release key is stored in the storage 12 (procedure E11), the first controller 2 acquires the current position of the terminal by using the current position detector (position information acquire module) 15 (procedure E12), and compares the acquired terminal position and the limitation release position information (procedure E13). When the current position is contained in the limitation release position information (procedure E14-YES), the first controller 2 releases contents viewing limitations (procedure E15) and halts the communication functions of the network communicator 7 (procedure E16).

After this, the controller of the mobile terminal device acquires the current position of the terminal by using the current position detector 15 every given period of time. When a terminal position does not match the limitation release position information (procedure E14-NO), the controller validates the contents viewing limitations (procedure E17), and starts the operation of the communication functions of the network communicator 7 (procedure E18).

In this example, even when the user exits from the facility without the viewing limitation release key being erased, the viewing limitation release key is automatically erased outside a valid scope of the key, and the communication functions of the network communicator 7 are automatically enabled. Therefore, the system can apply even in the case where the facility does not manage exits by the gate 4 or the like.

From the aforementioned description, according to the present invention, new services and contents are provided through the mobile terminal device in exchange for the prohibition or limitation of communication functions, thereby appealing strongly to users for the prohibition or limitation of communication function.

In turn, users can be provided with new service and contents in exchange for the prohibition or limitation of communication functions. In this case, it is particularly effective to provide services and contents specific to the facilities and places where communication by the mobile terminal device are limited or prohibited, because users can enjoy the service and contents even when they cannot use communication functions. Accordingly, the present invention can give a strong incentive for turning off communication functions to users and is extremely effective as a method of promoting the prohibition or limitation of communication functions in the specific facilities and places where communication by the mobile terminal device are prohibited or limited.

Although, in the above example, the current position detector 15 is based on GPS, the present invention is not limited to this when the current position of the mobile terminal device 1 can be acquired. For example, a communicator with an RFIC tag may be provided as the current position detector 15 to determine a current position from whether communication can be established with the tag placed within the facility. In this case, position information can be acquired even in places where GPS radio waves cannot be used.

A viewing limitation release key may be invalidated by time information. In this case, the mobile terminal device does not need to be provided with a GPS receiver and a detector for an RFID tag.

Although, in the examples described above, contents to be accessed are broadcast from a broadcast base station 4, a method of distributing contents may be whatever does not require communication with a network at the time of access. For example, contents may be received by communication with the short distance communication terminal 13. In this case, the mobile terminal device 1 does not need to include the broadcast receiver 3. As a result, the present invention can be implemented even in more inexpensive terminals. Also, since contents reception outside the facility is disabled, exits do not need to be managed using the exit gate 14 and the position detector 15.

Although, in the examples described above, communication with the short distance communication terminal 13 is made in non-contact mode, the present invention allows communication with the short distance communication terminal 13 through contact-type interfaces.

Further, contents may be distributed such that they are accessed after the whole contents have been downloaded. In this case, viewing limitations may not be placed on the contents. For example, in the procedure examples of FIGS. 2 and 3, contents themselves instead of the viewing limitation release key may be transferred, and the second controller halts the operation of the network communicator while the contents are stored in the storage. With this, the user can conveniently access the contents on demand.

A distributor of contents to be distributed may or may not be the facility.

In the case of the latter, although the facility must hold a contract with the contents distributor to enable facility users to access specific limited-viewing contents, the facility can implement the present invention without providing facility own contents. In the case of the former, the facility can distribute facility own contents to enable users to access contents closer to the facility.

Facilities referred to in the present invention include not only public facilities such as hospitals, trains, and libraries but also private facilities such as movies and amusement parks.

Hereinafter, a description is made of examples of concrete application of the present invention to individual facilities.

In hospitals, to reduce influence exerted on sensitive equipment such as pacemakers and medical equipment, communication functions of mobile terminal devices such as call and mail functions are turned off. In exchange, access can be made to bargain sale information of stores in the vicinity of the hospitals, special information of restaurants and stands inside the hospitals, or contents provided by the hospitals such as contents on health improvement and disease prevention. This enables the hospitals to appeal as ones careful of patients' health, and it is useful to users visiting the hospitals that contents on health improvement and disease prevention can be accessed. Also, contents on wait time at a hospital acceptance desk may be provided to the users, or service may be provided which make it possible to make reservations by the mobile terminal devices. Then, the system would become a user-friendly one.

In this case, the contents may be distributed not only by broadcast but also by any methods exerting no influence on the aforementioned pacemakers.

In trains, to prevent annoyance to other passengers, communication functions of mobile terminal devices such as call and mail functions are turned off. In exchange, access can be made to contents provided by rail road companies such as a timetable, bargain sale information of stores in the vicinity of stations, advertisements corresponding to strap advertisements and the like, and contents provided by sponsors. In this case, when the communication functions are automatically turned off during passage through a ticket barrier, the use of the communication functions can be limited without fail, and the provision of contents would deprive users of their desire to maliciously turn on the communication functions during riding. Moreover, in addition to paper-based advertisements such as strap advertisements that have so far been dominantly provided, image-based advertisements can also be realized, providing sponsors with more opportunities for appeals. Moreover, the users are also relieved of tedium within trains.

In movies and libraries, a conceivable form is to distribute attractive contents such as the release information of movies and books, and other noteworthy information.

Moreover, in amusement parks, a conceivable form is to provide a gate in a specific attraction so that communication functions are turned off automatically or at users' disposal, and enable the users to access the explanation of the attraction and other attraction-related contents such as give an incentive to turn off the communication functions and not turn on them for the duration of the attraction to the users. When such a form is employed, no annoyance would be given to other than those enjoying the attraction. Also, by employing such a form, the parties (e.g., amusement parks) providing attractions do not need to hire persons for the explanation of the attractions and can reduce labor costs. Also, attractions using mobile terminal devices can be distributed to provide attractions more attractive to users. In an embodiment of the present invention, the following form may be employed. Besides the aforementioned facilities, for example, regarding a car as a facility, with gates provided in the door of the car, parking areas and toll gates of expressways, and roads, in the course of driving, no communication is established with the car and contents such as traffic congestion information are transmitted from a base station periodically (e.g., at the time of passage through the toll gates). In this case, by limiting communication functions in the course of driving, safety in driving can be maintained and contents useful to the user such as traffic congestion information can be distributed. Moreover, in this case, by providing the car with a broadcast base station, safety in driving can be maintained more securely.

In the present invention, as the network base station, transmitters of digital signals and analog signals such as base stations of mobile terminal devices and small-sized antennas of PHS are included.

Contents may be distributed from a network communication base station.

In this case, the network communicator halts only the transmission of radio waves to the network base station and has a receivable, receive-only operation mode to receive radio waves from the network base station. The network base station distributes contents through a specific channel, and the controller controls the network communicator so that contents can be received through the channel only when the network communicator is set in the receive-only operation mode. This control forces the user to switch the network controller to the receive-only operation mode to access contents distributed from the network base station, providing motivation to halt the transmission of radio waves from the mobile terminal device.

In the case where the transmission of radio waves is to be halted only within a specific facility (e.g., train and hospital), control is performed so that contents distributed through a predetermined channel of the network base station can be accessed only when two conditions—the user is present within the facility and the network controller is set in the receive-only mode—are satisfied. Whether the user is present can be detected in the same way as at the reception of contents from the broadcast base station. Specifically, entrance and exit is managed by short distance communication using, e.g., Bluetooth or the like, between the mobile terminal device and the short distance communication terminal provided at an entrance/exit gate of the facility, and the controller performs control so that information indicating entrance is stored in the storage at the time of entrance and the information is erased at the time of exit. When the mobile terminal device has a position detector such as GPS, it may be used to determine whether the user is present within the facility. Also, the terminal may be provided with a detector for RFIC tag or the like to periodically search for RFID tag at the start of access to contents and during accessing of the contents. Also, it may be determined whether the user is present within the facility by determining whether a specific signal receivable within the facility can be received by the mobile terminal device when it has a detector for the signal. As a result, radio communication can be halted without bringing the mobile terminal device near the short distance communication terminal provided at the entrance/exit gate of the facility. By installing the short distance communication terminal everywhere in the facility, radio communication can be continuously halted.

A congestion level of a train and a hospital can be estimated by obtaining position information about users within the facility by GPS, and by offering the congestion level information to other users, congestion can be relieved. Such a service brings advantages to the users and improves the image of the enterprise and hospital providing the service aside from economic advantages, eventually providing the enterprise and the like with advantages. The hospital and the like providing the service and product will also be able to examine more patients as a result of congestion being relieved.

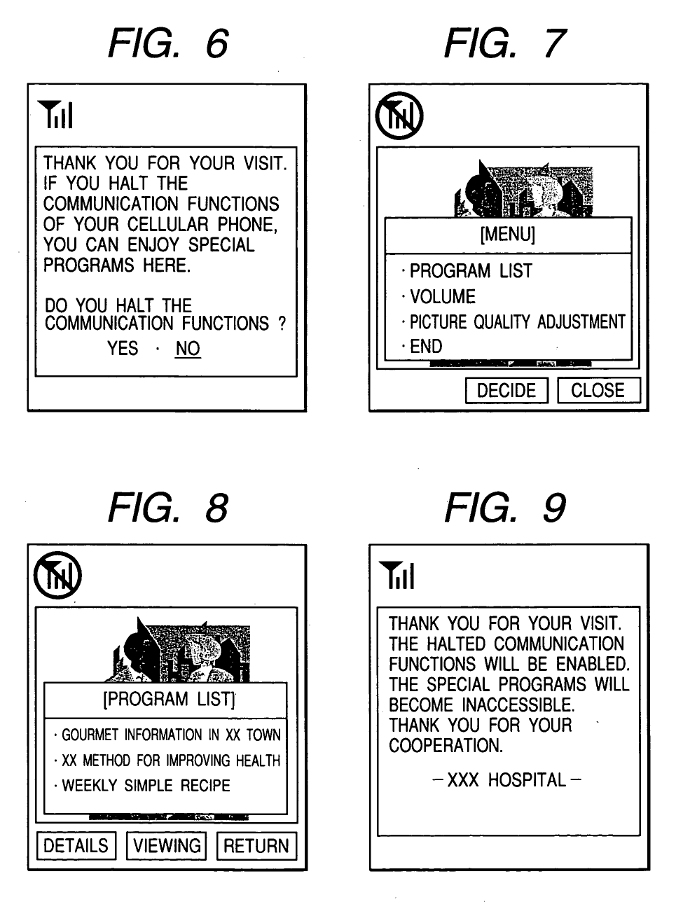

FIGS. 6 to 9 show examples of display screens. When a user enters a hospital, the screen of FIG. 6 is displayed to prompt the user to halt communication functions of a mobile terminal device in exchange for contents distribution. When the user selects “Yes” to halt the communication functions, the menu screen of FIG. 7 is displayed. At this time, the communication functions have already been halted. Next, when the user selects “Program list” from the menu, a list of programs that can be accessed in exchange for the communication functions is displayed on the screen, as shown in FIG. 8. As shown here, it is preferable that the contents are so attractive to the user of the mobile terminal device that the user is willing to prohibit or limit the communication functions. For example, an incentive can be given to the user when such contents as follows are provided; the contents are related to a user's place such as information on health care and disease prevention in the case of hospital and gourmet information in the vicinity of stations along a railroad line in the case of train. At this time, options such as “Yes” may be selected by a decision button or the like of the mobile terminal device.

As shown in FIG. 9, in the case where contents distribution is to be halted upon exit from the hospital, a screen indicating the restoration of the communication functions is displayed. The decision is brought into effect by pressing down the decision button.

Next, a description is made of the flow of wireless telephone communication signals provided by the network communication base station. Usually, wireless telephone communication signals (or program) are transmitted from the network base station and received in the mobile terminal device. However, upon entry to a predetermined area such as a hospital or train, contents are received by the broadcast receiver of the mobile terminal device, and the reception of the wireless telephone communication signals is halted.

Alternatively, control may be performed so that the wireless telephone communication signals are received in the mobile terminal device but not transmitted from the mobile terminal device to the network base station.

It is assumed here that the wireless telephone communication signals also include signals (or program) necessary to communicate calls and Internet mail.

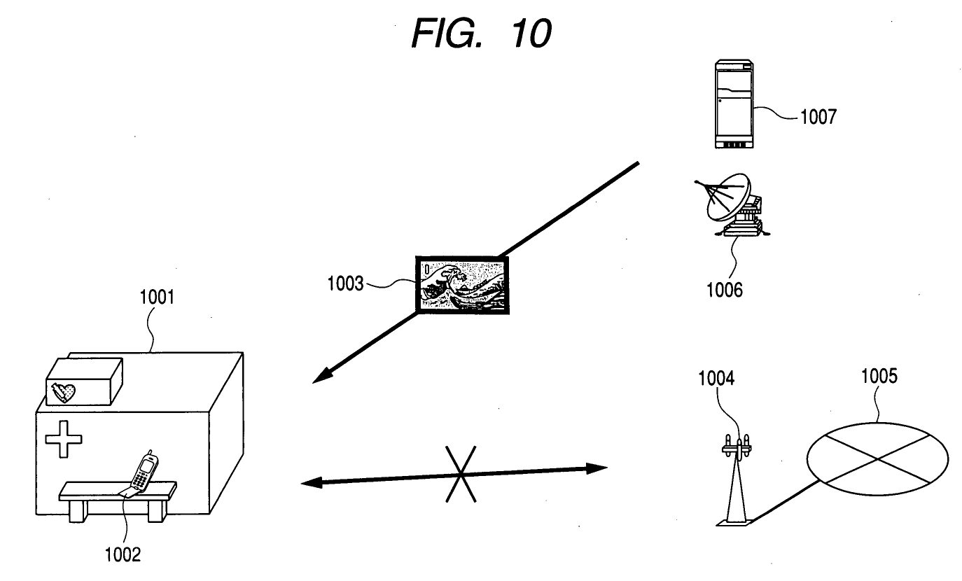

Next, a description is made of what business forms are conceivable to implement the present invention. First, it is considered the case where a communication carrier serves as an administrator of the present invention. In a system shown in FIG. 10, there may be a case where a communication carrier owns both a network base station 1004 and a contents server 1007 (or broadcast base station 1006). In another case, a broadcast base station 1006 may be owned by a hospital 1001 and the network base station 1004 may be owned by the communication carrier.

By distributing contents from the broadcast base station, the network base station, and the contents distribution server without cost or without cost except packet fees, the image of the enterprise can be improved. It is also a good idea not to charge either of distribution fees and packet fees.

It is to be noted that contents refer to information viewable on a screen of a mobile terminal device, such as video signals, TV signals, or/and programs such as applications.

According to the aforementioned embodiment, the communication carrier providing communication by mobile terminal devices from the network base station cannot charge communication fees as long as users are within a hospital or the like. However, by actively providing service for turning off communication functions in the hospital or train, influence on sensitive equipment such as medical equipment can be reduced and the operation of the sensitive equipment can be stabilized. This helps to provide the public and customers with the impression that the enterprise places special emphasis on rigid adherence to or/and compliance with manners and makes a contribution to society, leading to improvement in the image of the enterprise.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and range of equivalency of the claims are therefore influenced to be embraced therein.

1. A program received in a mobile terminal device,
wherein the mobile terminal device has a button, and when the button has been pressed, the program is received by the mobile terminal device in exchange for a wireless communication signal being unable to be transmitted from the mobile terminal device.

2. A signal processing system for a wireless communication signal that uses a mobile terminal device, a server, and a network base station transmitting the wireless communication signal,
wherein the mobile terminal device has a decision button for making a decision not to transmit the wireless communication signal to the network base station in exchange for receiving predetermined contents transmitted from the server, and
when the decision button has been pressed down, the wireless communication signal is not transmitted from the mobile terminal device to the network base station, and predetermined contents transmitted from the server are received by the mobile terminal device.

3. The signal processing system according to claim 2,
wherein the wireless communication signal is a program for telephone communication used when the mobile terminal device makes telephone communication with other mobile terminal device.

4. The signal processing system according to claim 2,
wherein the predetermined contents are transmitted in a place where the use of the mobile terminal device is limited, whereby the prevention of the use of the mobile terminal devices is promoted, so that the image of an enterprise administering the system can be improved.

5. The signal processing system according to claim 2,
wherein the predetermined contents are transmitted in a place where the use of the mobile terminal device is limited, whereby the prevention of the use of the mobile terminal device is promoted, so that rigid adherence to manners can be achieved.

6. The signal processing system according to claim 2,
wherein the predetermined contents are transmitted in a place where the use of the mobile terminal device is limited, whereby the prevention of the use of the mobile terminal device is promoted, and the prevention of annoyance to other people and the rigid adherence to or compliance with manners are achieved, so that the image of an enterprise administering the system can be improved.

7. The program according to claim 1, comprising a step of displaying the name of a distributor of the program on a display screen of the mobile terminal device.

8. The program according to claim 1, comprising the steps of:
prohibiting the transmission of a call signal or/and a mail communication signal from the mobile terminal device; and
starting applications viewable in the mobile terminal device,
wherein, when the program has been received in the mobile terminal device, calls or/and mail communication by the mobile terminal device are prohibited.

9. The program according to claim 1, comprising the step of
prohibiting the transmission of a call signal or/and a mail communication signal,
wherein, when the program has been received in the mobile terminal device, calls or/and mail communication by the mobile terminal devices are prohibited, and in exchange, contents viewable in the mobile terminal device are added.

10. A contents distribution method comprising the steps of:
adding a signal for prohibiting the transmission of a call signal or/and a mail communication signal from a mobile terminal device to contents viewable in the mobile terminal device;
distributing the contents to the mobile terminal device; and
prohibiting calls or/and mail communication by the mobile terminal device when the contents have been received in the mobile terminal device.
